(19) United States
(12) Patent Application Publication
(10) Pub. No.: US 2025/0383264 A1
(43) Pub. Date: Dec. 18, 2025

(54) MOTORCYCLE TEST STAND

(71) Applicant: AVL List GmbH, Graz (AT)

(72) Inventor: Christian Schyr, Heidelberg (DE)

(21) Appl. No.: 18/835,596

(22) PCT Filed: Feb. 2, 2023
(86) PCT No.: PCT/AT2023/060027

§ 371 Date: Aug. 2, 2024

(30) Foreign Application Priority Data
Feb. 4, 2022 (AT) A50061/2022

(51) Int. Cl. G01M 17/007; G09B 9/058

(52) U.S. Cl. CPC G01M 17/0076; G09B 9/058

(57) ABSTRACT

The invention relates to a vehicle test stand for carrying out a test run with a complete vehicle capable of banking, characterized in that a steering force module is provided on the vehicle test stand, which can be connected to a steering system of the banking-capable complete vehicle, a steering angle detection unit is provided for determining a steering angle (αM) of the steering system during the test run, a detection unit is provided for detecting a position (αL) of a driver relative to the banking-capable complete vehicle during the test run, a simulation unit is provided, which is designed to use the steering angle (αM) and the position (αL) of the driver in a simulation model in order to calculate a steering counter force (QA) acting on the steering system and counteracting a steering force (QL) exerted by the driver, and the steering force module is designed to apply the steering counter force (QA) to the steering system.

The present invention relates to a vehicle test stand and a method for carrying out a test run with a banking-capable complete vehicle. In order to test driver assistance systems, such as anti-lock braking systems, cruise control systems, airbag systems, lane assistants, stabilization systems, etc., as well as autonomous functions of a drivable complete vehicle, it is possible with comprehensive road and traffic models to simulate vehicle movements in a virtual environment. For this purpose, sensors installed in the vehicle (ultrasonic sensors, cameras, radar, GPS trackers, lidar, etc.) as well as communication devices or communication protocols integrated into the vehicle, not only car-to-car (C2C) but also infrastructure-to-car (I2C) or also vehicle-to-everything (V2x), are connected to a simulation platform and emulated or simulated.

In addition, it is desirable to operate the complete vehicle under the same energetic conditions as in a real driving test. This allows safety-critical driving maneuvers to be integrated into the simulation under reproducible conditions, including human interaction. The complete vehicle or a part thereof, e.g., a drive train and/or the steering system, is built and operated as real hardware on a vehicle test stand. The forces, torques, etc., calculated in the simulation are applied to the complete vehicle on the vehicle test stand by means of suitable actuators, so that the complete vehicle, which is fixed in place on the vehicle test stand, experiences the same driving conditions as the virtual complete vehicle in the simulation. For this purpose, on the vehicle test stand, forces and/or torques must be applied to the complete vehicle, in particular to the steering system and the drive train.

In the case of banking-capable complete vehicles, such as motorcycles, scooters, or even motor-assisted bicycles and e-bikes, the driver's behavior during a driving maneuver has a major influence on the driving behavior of the complete banking-capable complete vehicle. This can also be the case, for example, with other variants of complete vehicles that have more than two wheels, such as three-wheeled variants of sidecar motorcycles or scooters, such as the Piaggio MP3 series. The present invention, with the term “banking-capable complete vehicle,” thus includes all two-wheeled, three-wheeled, or possibly even multi-wheeled vehicles which essentially lean into a banking position during driving maneuvers. These can be controlled accordingly by shifting the driver's weight.

During the entire journey, the stature and weight of the driver, for example, influence weight distribution on the vehicle frame and on the steering system. Depending upon the banking-capable complete vehicle and upon the driver, this can lead to juddering, wobbling, or handlebar kickback depending upon speed and upon the condition of the road surface. The driver's steering technique plays a decisive role in steering the banking-capable complete vehicle, especially in curves. A rough distinction can be drawn between the steering techniques for banking, pushing, and hanging. When banking, the motorcycle (as an example of a banking-capable complete vehicle) tilts in the direction of the curve, and the rider moves in the same position in relation to the axis of a steering system. In the case of pushing, the motorcycle tilts further in relation to the rider, thus placing the rider in a more upright position relative to the axis of the steering system. In the case of hanging, the opposite of pushing is the case, viz., that the driver is in a more inclined position relative to the axis of the steering system and close to the road surface.

The different steering techniques have an influence on the lateral forces acting on the banking-capable complete vehicle and thus on stability during travel. For this reason, a realistic simulation on the vehicle test stand can be carried out only when the position of the driver relative to the complete vehicle is taken into consideration.

WO 2018/046609 A1 describes a vehicle test stand with different actuators on the vehicle test stand for the roller and drive-train test stand, and for the lateral forces in a complete vehicle. No effect of the driver's behavior on the lateral forces in a complete vehicle is disclosed.

WO 2018/170523 A1 discloses an improved vehicle test stand for motorcycles, wherein, however, only actuators for drive-train testing are disclosed, but no measurement of the possible lateral forces is made possible.

EP 2915155 B1 describes a motorcycle simulation system for entertainment purposes, wherein the wheels are supported on rollers, and a mechanical support device makes possible a banked position of the motorcycle.

Driving simulations for training and entertainment purposes are well known in the prior art. However, such simulation systems cannot be used for development, because a large number of necessary instruments, measurement sensors, and power actuators are missing.

The object of the present invention is therefore to provide a vehicle test stand for banking-capable complete vehicles, which makes possible a more realistic simulation of driving conditions occurring during operation.

This object is achieved in that a steering force module that can be connected to a steering system of the banking-capable complete vehicle is provided on the vehicle test stand, that a steering angle detection unit is provided for detecting the steering angle of the steering system during the test run, that a detection unit is provided for detecting a position of a driver relative to the banking-capable complete vehicle during the test run, that a simulation unit is provided which is designed to use the steering angle and the position of the driver in a simulation model in order to calculate a steering counter force acting on the steering system and counteracting a steering force exerted by the driver, and that the steering force module is designed to apply the steering counter force to the steering system.

This is advantageous because not only is the steering angle measured during the test run, but the driver's position is also detected via the detection unit during the test run. This makes it possible to transfer a steering force to the steering force module by means of the simulation unit and to achieve a realistic load on the motorcycle by means of an actuator, even in the case of different steering techniques. On the one hand, the driver experiences the dynamic restoring force through the steering counter force, just as in real driving. On the other hand, stability problems on the banking-capable complete vehicle can be detected and remedied at an early stage on the vehicle test stand in a safe environment for the driver. A very wide variety of driver assistance systems can also be tested in dangerous situations in a realistic manner on the vehicle test stand.

In a preferred embodiment, a vertical axis of the banking-capable complete vehicle is in the same, preferably vertical, test position during the entire test run. This is advantageous because it eliminates the need for pneumatic or mechanical actuators to move the banking-capable complete vehicle into a banking position. This makes it easier to install the necessary instrumentation, measurement sensors, and power actuators on the vehicle test stand.

In a further preferred embodiment, a loading unit can be provided for driving and/or loading the banking-capable complete vehicle, in particular in order to exert a torque on a component of a drive train of the banking-capable complete vehicle. This means that even the drive train of a banking-capable complete vehicle can be tested during a test run. This can, for example, be performed only at the front wheel or at the rear wheel. However, it is also possible for a loading unit to be provided on all wheels, i.e., front wheel and rear wheel, or on several wheels in the case of multi-wheeled vehicles, which behave like a banking-capable complete vehicle.

In a further preferred embodiment, the loading unit can have at least one roller on which a rear wheel or a front wheel of the banking-capable complete vehicle can be positioned. There can also be one roller per wheel, which can be advantageous, for example, in the case of all-wheel drive systems in which there are several driven wheels.

In a further preferred embodiment, the steering angle detection unit can be arranged in the steering force module. In this way, the equipment required on the test stand can be minimized. Furthermore, the effects of the steering counter force on the steering angle can be measured directly in a single unit.

In a further preferred embodiment, a test run unit can be provided which is designed to perform predefined reference maneuvers on the vehicle test stand during the course of the test run. This means that data captured by a test vehicle during a real journey can be used on the vehicle test stand. The test driver can thus be given a realistic driving maneuver on the test stand. Open-loop operation or closed-loop operation can be provided. In open-loop operation, the driver follows a given reference maneuver as accurately as possible. In closed-loop operation, for example, interactions with other (virtual) road users are provided to which the driver reacts according to the situation.

In a further preferred embodiment, the test run unit can be designed to prespecify stored data to an environmental model, and environmental conditions can be simulated during the test run. Weather, terrain, road conditions, and/or other virtual road users can thus be specified on the vehicle test stand and passed to the driver or the banking-capable complete vehicle via the simulation model. Simulations of dangerous situations, such as slipping or locking of tires, can thus be performed on the vehicle test stand.

In a further preferred embodiment, a visualization unit can be provided on the vehicle test stand in order to generate a virtual driving environment during the test run. This makes it possible for a test driver to perceive even visual stimuli during a test run. Reference maneuvers can thus also be displayed via the visualization unit. For example, the driver can be shown recorded real journeys so that he can orient his position on the vehicle to correspond to that on the real journey, which is particularly advantageous in the case of cornering.

In a further preferred embodiment, the simulation model may have a multi-body model, wherein the multi-body model preferably has a vehicle model and a driver model. Forces and torques acting on the driver and/or upon the banking-capable complete vehicle can thus be simulated in the simulation model. The load limits of the driver and/or of the complete vehicle can thus be tested using the simulation model without endangering the test driver and/or the complete vehicle.

In a further preferred embodiment, the vehicle test stand can have a brake pressure measurement unit which is designed to measure a brake pressure in a brake system of the complete vehicle, and that the simulation unit and/or the test run unit is designed to use the detected brake pressure to determine a virtual braking torque. This is advantageous because brake pressure can be emulated and/or measured even when the wheel is unloaded or stationary. This means that assistance systems, such as an anti-lock braking system (ABS), which require brake pressure, can also be tested on the vehicle test stand.

In a further preferred embodiment, the vehicle test stand can have a rotational speed signal unit, wherein the rotational speed signal unit is designed to emulate a wheel rotation signal to an unloaded or stationary front wheel or rear wheel. This means that a rotation signal can also be emulated on the unloaded or stationary wheel in the vehicle test stand. This is advantageous because it also allows testing of assistance systems that require a rotation signal on all wheels.

In a further preferred embodiment, the simulation unit can be designed to specify a target steering counter force to a force controller, and the force controller is further designed to determine a steering counter force value control variable. This makes possible a precise closed-loop control of the target values of the simulation unit. In this way an even more realistic representation of a journey with the banking-capable complete vehicle can be achieved.

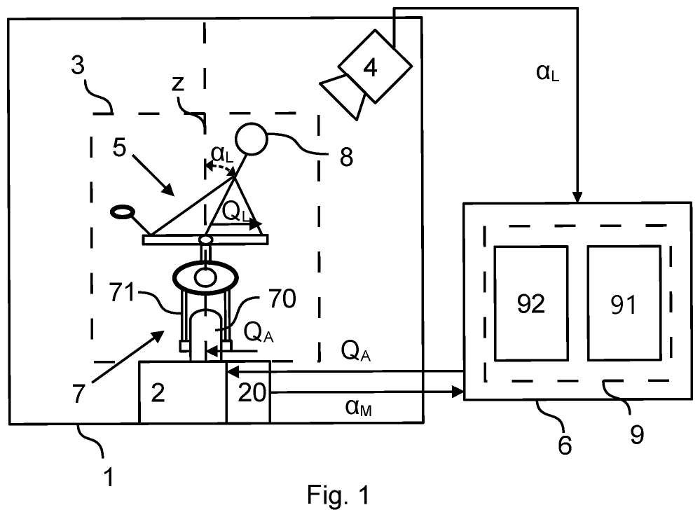

The present invention is described in greater detail below with reference to FIGS. 1 to 3, which show exemplary, schematic, and non-limiting advantageous embodiments of the invention. In the figures:

FIG. 1 shows the vehicle test stand according to the invention for a banking-capable complete vehicle,

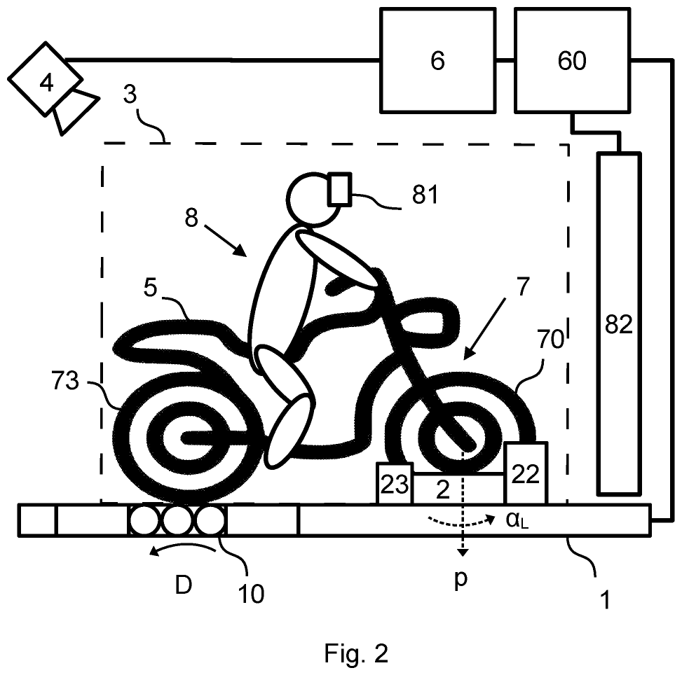

FIG. 2 shows an advantageous embodiment of the vehicle test stand according to the invention, and

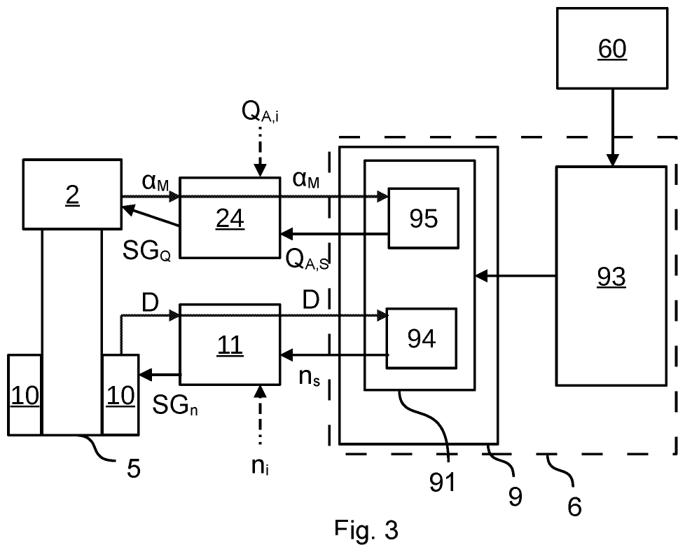

FIG. 3 shows an advantageous embodiment of signal transmission on the vehicle test stand.

FIG. 1 shows a vehicle test stand 1 with a banking-capable complete vehicle 5. The banking-capable complete vehicle 5 can be a motorcycle, a moped, or even a motor-assisted bicycle or even a bicycle (such as an e-bike), and often has two wheels. However, banking-capable complete vehicles 5 are also conceivable which have more than two wheels, which can be brought into a banking position during the drive and therefore behave essentially like a banking-capable complete vehicle 5 with two wheels. The vehicle test stand 1 can be designed for any type of drive of the banking-capable complete vehicle 5. This means that, as well as banking-capable complete vehicles 5 with a combustion engine, electric motor or other types of drives can be tested on a vehicle test stand. Understandably, depending upon the design of the banking-capable complete vehicle 5, the vehicle test stand 1 has the necessary analytical and sensor systems to carry out all necessary measurements during a test run, such as power, consumption, exhaust emissions, or drivability measurements.

The banking-capable complete vehicle 5 has a steering system 7, which, as is known, can have a steering mechanism 71 and a front wheel 70. A steering system 7 has the usual components of a steering mechanism 71 of a banking-capable complete vehicle 5, with which a person skilled in the art is sufficiently familiar. Typically, the front wheel 70 is arranged so as to be steerable relative to the frame of the banking-capable complete vehicle 5—for example, via at least one handlebar tube. The front wheel 70 itself can be connected to the steering mechanism 71 via a fork.

A steering force module 2 is also provided on the vehicle test stand 1, wherein the steering system 7 of the banking-capable complete vehicle 5 can be connected to the steering force module 2. The steering force module 2 has at least one suitable actuator with which a force can be applied to the steering system 7. The steering force module 2 can, for example, have a base body which can be arranged on the vehicle test stand 1, as well as an actuator element which can be moved relative to the base body and which acts upon the steering system 7. The steering force module 2 can preferably be positioned in a suitable manner on the vehicle test stand 1, so that a wide variety of banking-capable complete vehicles 5 of different sizes can be fixed to the steering force module 2. After positioning the steering force module 2, the base body of the steering force module 2 can be locked in place on the vehicle test stand 1. Of course, the base body of the steering force module 2 could also be fixedly, i.e., immovably, arranged on the vehicle test stand 1.

The front wheel 70 can itself be fixed to the steering force module 2, e.g., to the movable actuator element, or the steering mechanism 71 can be fixed without the front wheel 70 to the steering force module 2, in particular to the movable actuator element. For example, the steering force module 2 can be connected to a fork of the steering mechanism 71 of the banking-capable complete vehicle 5. Power electronics can also be arranged on or in the steering force module 2 in order to supply the steering force module 2 with electrical power in a suitable manner. The power electronics can also be arranged in a separate unit—for example, for the entire vehicle test stand 1.

Furthermore, according to the invention, a steering angle detection unit 20 is provided on the vehicle test stand 1. The steering angle detection unit 20 detects a steering angle α_{M} of the steering system 7 during a test run. The steering angle α_{M} is understood to be the angle at which the steering mechanism 71, in particular the front wheel 70, is deflected relative to the banking-capable complete vehicle 5. The steering angle α_{M} can, for example, correspond to a rotation angle by which the steering mechanism 71 rotates in the handlebar tube. This can be done using optical, mechanical, or electrical methods, for example. Depending upon how the steering system 7 is fastened to the steering force module 2, the steering angle α_{M} can be detected—for example, at the front wheel 70 and/or on the steering mechanism 71 of the steering system 7. The steering angle detection unit 20 can either be provided as a separate unit or be integrated into the steering force module 2. The steering angle α_{M} preferably rotates in a range of 0-45° around a steering axis—for example, the handlebar tube of the banking-capable complete vehicle 5.

According to the invention, a detection unit 4 is also provided on the vehicle test stand 1. In order to detect a position α_{L} of the driver 8 on and/or relative to the banking-capable complete vehicle 5, the detection unit 4 monitors a driver area 3 within which a driver 8 is located during the test run. Depending upon the driving maneuver, only the position α_{L} of the driver on the banking-capable complete vehicle 5 may be of interest—for example, when driving a straight course with no curves. During cornering, the position α_{L} of the driver in relation to the banking-capable complete vehicle 5 can also be important—for example, when hanging or pushing in a curve. The detection unit 4 detects at least the position α_{L} of the driver in relation to the banking-capable complete vehicle. Preferably, however, the banking-capable complete vehicle 5 is also located within the driver area 3.

For example, the position α_{L} of the driver 8 may depend upon the type of banking-capable complete vehicle 5. For example, the position α_{L} of the driver 8 is usually more upright on off-road motorcycles than on street motorcycles. During normal operation, the position α_{L} of the driver 8 may also depend upon wind, road, and terrain conditions or upon his state of fatigue. Furthermore, the position α_{L} of the driver 8 during steering depends upon the situation-specific steering technique applied, such as banking, pushing, or hanging. For example, banking and pushing are used in the normal operation of a banking-capable complete vehicle 5 in road traffic, while hanging is used in competitive sports on the racetrack. The position α_{L} of the driver 8 can also affect the steering angle α_{M}. As a rule, the greater the banking of the driver 8 is, the smaller the steering angle α_{M} will be. Consequently, the steering angle α_{M} and the driver's position α_{L} are usually related.

The detection unit 4 transmits the position α_{L} of the driver 8 to a simulation unit 6 provided on the vehicle test stand 1, and the steering angle detection unit 20 also transmits the steering angle α_{M} to the simulation unit 6. This transmission can take place via a data cable, for example, but it is of course also possible for the data communication to take place wirelessly—for example, via WLAN, Bluetooth, etc. The simulation unit 6 can be microprocessor-based hardware (e.g., a computer), an integrated circuit such as a field programmable gate array (FPGA) or an application-specific integrated circuit (ASIC), also with a microprocessor, or also an analog circuit or analog computer. Mixed forms are conceivable as well. The simulation unit 6 can also be part of a test stand control unit (not shown), via which the essential functions of the vehicle test stand 1 can be controlled.

A simulation model 9 is implemented in the simulation unit 6, wherein the simulation model 9 uses the detected position α_{L} of the driver 8 and the detected steering angle α_{M}. Advantageously, a steering force Q_{L} applied by the driver 8 to the steering system 7 of the banking-capable complete vehicle 5 can be determined therefrom. The steering force Q_{L} can depend upon the steering technique of the driver 8, but also upon his body stature, i.e., his height and weight, and upon his seating position on the banking-capable complete vehicle 5. However, any other force that the driver 8 exerts on the banking-capable complete vehicle 5 can also be determined in the simulation model 9. This means that the steering force Q_{L} can be oriented in a certain direction and can be given in the form of a vector or an acting torque. Of course, the steering force Q_{L} can also depend upon the banking-capable complete vehicle 5 that is to be tested. For example, in the case of an off-road motorcycle, due to the center of gravity and the position of the driver 8, a different steering force Q_{L} will naturally act upon the steering system 7 than, for example, in the case of a street motorcycle. It may also be possible that only the steering force Q_{L} relative to the vertical axis z of the banking-capable complete vehicle 5 is considered, as shown by way of example in FIG. 1. For this reason, it can be provided that only the components of the steering force Q_{L} in one defined direction are to be considered.

In an advantageous embodiment, a multi-body model is used as simulation model 9. The multi-body model may contain a vehicle model 91 and a driver model 92. However, it is also conceivable that either a vehicle model 91 or a driver model 92 is contained in the multi-body model. A vehicle model 91 can calculate in detail all forces and/or torques acting on various components of the banking-capable complete vehicle 5. For example, the vehicle model 91 may contain a model for the frame and/or for the drive and/or for the tires and/or for the steering mechanism of the banking-capable complete vehicle 5. Furthermore, an environmental model 93 can also be included (FIG. 3), which interacts, for example, in combination with a test run unit 60 described below and simulates environmental conditions, and can, for example, calculate and/or simulate a terrain, such as road conditions, traffic load, and weather conditions. For example, a wind machine can be provided which simulates a headwind during the test run. The interaction between the driver 8 and the banking-capable complete vehicle 5 can thus be simulated in a realistic manner.

This is also advantageous, because, in the vehicle model 91, the forces and torques acting on the frame and/or tires and/or upon the steering system 7 during a test run can thus be calculated, e.g., due to the load from the driver 8, and thus the stability of the banking-capable complete vehicle 5 during different simulated driving maneuvers can be estimated. In this way, dangerous situations can be simulated, and the effectiveness of assistance and safety systems can thus be tested.

The simulation unit 6 can also use the simulation model 9 to calculate from the steering force Q_{L} a lateral force acting on the complete vehicle 5. The lateral force can be taken into account when considering the stability of the banking-capable complete vehicle 5. If, for example, the lateral force is too high, the banking-capable complete vehicle 5 would slip during the test run, e.g., in a tested dangerous situation, or juddering, wobbling, or handlebar kickback could occur in the simulation model 9. However, material failure in the banking-capable complete vehicle 5 can also be considered. Advantageously, not only the steering force Q_{L} applied to the steering system 7 is calculated, but also that applied to other components of the banking-capable complete vehicle 5, such as for example to the rear wheel 73 or to the frame. Dangerous situations can thus be simulated on the vehicle test stand without endangering the driver.

According to the invention, the simulation unit 6 determines at least one steering counter force Q_{A} and transmits it to the steering force module 2, and the steering force module 2 applies the steering counter force Q_{A} to the steering system 7 of the banking-capable complete vehicle 5. The steering counter force Q_{A} is the force that counteracts a steering force Q_{L} generated by the driver 8. The steering counter force Q_{A} is thus essentially a restoring force acting on the steering system 7, which attempts to move the steering system 7 into a stable position. The steering counter force Q_{A} can, for example, depend upon vehicle parameters of the banking-capable complete vehicle 5, such as the tires used, as well as upon environmental parameters, such as the surface of the road. The vehicle parameters and environmental parameters can be defined in the simulation model 9 and preferably can be modified, in particular in the vehicle model 91 and in the environmental model. This is advantageous because the driver can thereby perceive the steering counter force Q_{A} acting on the steering system 7 during the test run and can adapt his driving behavior accordingly—for example, by going further into a (perceived) banking angle or by reducing the banking angle. This is advantageous because it allows dangerous situations to be reproduced without endangering the driver. For example, the steering counter force Q_{A} can be used to apply handlebar kickback to the steering force system 7. Advantageously, however, even a lateral force can be used in the simulation model 6 in calculation of the steering counter force Q_{A}. In this way, a very precisely acting steering counter force Q_{A} can be calculated, and thus the forces acting in reality can be reproduced on the vehicle test stand 1.

In an advantageous embodiment, the vertical axis z of the banking-capable complete vehicle 5 can be in the same test position during the entire test run. Consequently, the banking-capable complete vehicle 5 cannot be moved into a banking position during the execution of a steering maneuver in the test run, but the vertical axis z remains in the same position—for example, aligned normally to a base area of the vehicle test stand 1. The steering counter force Q_{A} is thus used to simulate for the driver during the test run the restoring force acting on the steering system 7 when the banking-capable complete vehicle 5 is in a banking position.

FIG. 2 shows an advantageous embodiment of the vehicle test stand 1 according to the invention. In addition to the steering force module 2, the vehicle test stand 1 can also have a loading unit 10. The loading unit 10 is provided for driving and/or loading the banking-capable complete vehicle 5—for example, in order to apply a torque D to a drive axle of the banking-capable complete vehicle 5. The loading unit 10 can, for example, have one or more rollers on which the rear wheel 73 of the banking-capable complete vehicle 5 is arranged, as shown in FIG. 2. However, it is also conceivable that the loading unit 10 can be connected directly via a suitable connecting shaft to a drive shaft of the engine, to a transmission shaft of a transmission, or to a chain ring of the chain of the banking-capable complete vehicle 5.

The loading unit 10 can also be installed at the front wheel 70, in addition to the steering force module 2, or can be installed at both the front wheel 70 and the rear wheel 73. It is also conceivable that the steering force module 2 and the loading unit 10 be installed together in a single unit. A plurality of loading units 10 can also be provided in the vehicle test stand 1. This can be advantageous if the banking-capable complete vehicle 5 has all-wheel drive, and thus both wheels 70, 73 can be loaded simultaneously. A load state of the engine of the banking-capable complete vehicle 5 can also be recorded during the test run via loading unit 10 or corresponding sensors in the loading unit 10.

The wheel rotational speed of a driven wheel 70,73 can, for example, also be used to emulate the wheel rotational speed of a non-driven, in particular stationary, wheel 70, 73. For this purpose, for example, a rotational speed signal unit 22 can be provided on the vehicle test stand, e.g., as part of the loading unit 10, or the rotational speed signal of a vehicle-mounted rotational speed sensor can also be used. This is advantageous if only one wheel, e.g., the rear wheel 73, is loaded by the loading unit 10, while at least one other wheel, e.g., the front wheel 70, is stationary. When a driven wheel, e.g., the rear wheel 73, is loaded, the vehicle-mounted wheel rotational speed sensor of the stationary wheel, e.g., of the front wheel 70, does not emit a signal, and assistance systems such as an anti-lock braking system (ABS) can indicate a fault or even go into a fault state. For this reason, a realistic simulation of the wheel rotational speed signal by means of appropriate electronics (emulation) is advantageous, since this can prevent the fault or fault state.

Furthermore, a brake pressure measurement unit 23 can be provided for measuring the brake pressure p in a brake system of the banking-capable complete vehicle 5. To measure the brake pressure p, the brake pressure measurement unit 23 is advantageously mounted on the brake hose by means of a T-piece. If only one wheel, e.g., the rear wheel 73, is loaded by the loading unit 10, only the pressure signal of the brake pressure p in, for example, the brake hose may be available at the front wheel 70. By means of the brake pressure measurement unit 23, the brake pressure p can be measured and sent to the simulation unit 6. The simulation unit 6 can use this to determine a virtual braking torque on the non-driven wheel, e.g., the front wheel 70, during a test run on the vehicle test stand 1. This makes possible a realistic distribution of the braking torque between the front and rear axles in the simulation for the banking-capable complete vehicle 5.

In this way, by measuring the brake pressure 9 by means of the brake pressure measurement unit 23, a dangerous situation can be detected, and endangering the driver can be avoided. Such a dangerous situation can occur during operation, for example, if a wheel locks, and the skidding or slipping associated with this occurs. Furthermore, it is thereby possible to analyze the effect of an anti-lock braking system (ABS) and its behavior at different brake pressures p.

Furthermore, a test run unit 60 can be present, which has stored a number of reference maneuvers and specifies these on the vehicle test stand 1 during the test run. The test run unit 60 can in turn be integrated, for example, into the higher-level test stand control unit (not shown). The reference maneuvers can, for example, be real data recorded from real test drives with test vehicles. The real data can be captured via a large number of sensors in a test vehicle and then stored as a reference maneuver in the test run unit 60. Examples of reference maneuvers can be braking when driving straight ahead, steady/non-steady cornering, slalom driving, evasive maneuvers, serpentine driving, or the like. A test run unit 60 may be connected to an environmental model 93, which uses the stored reference maneuvers to simulate on the vehicle test stand traffic, terrain, weather conditions, road users, and more, as shown in FIG. 3. The reference maneuver can then be set for a driver 8, and the driver 8 performs the reference maneuver. Real data and data from the test run can then be compared with the aid of the reference maneuver. The test run unit 60 can advantageously be operated in two different ways:

In open-loop operation, time-based recorded reference maneuvers can be specified on the vehicle test stand 1 and visualized correspondingly for the driver 8 via a visualization unit 81, 82 (as discussed below) so that the driver 8 can follow the time-based recorded reference maneuvers as accurately as possible. This allows, for example, the driver 8 to adapt his driving style on the vehicle test stand 1 so that it corresponds as closely as possible to the driving style in the real trial, or the quality of the signals on the test stand can be directly compared with real trials.

In closed-loop operation, the test run unit 60 can specify a test scenario as a reference maneuver, such as driving up to and then overtaking another road user or crossing the path of another vehicle or a pedestrian. During the test run, the driver 8 on the banking-capable complete vehicle 5 interacts with the virtual road users by performing appropriate driving maneuvers and is supported by the visualization unit 81, 82.

The test run unit 60 can furthermore create a virtual driving environment (virtual reality) on the vehicle test stand 1. For this purpose, a visualization unit 81, 82 can be provided, which can be designed as mixed-reality glasses 81 or even in the form of a monitor 82 on the vehicle test stand 1 itself. The driver is thus shown a real driving maneuver, e.g., a curve, by the visualization unit 81, 82 and can adapt his driving style on the vehicle test stand 1 accordingly. Recording and analysis are carried out via the apparatus according to the invention, as sufficiently described in FIG. 1.

It is of course also conceivable that the visualization unit 81, 82 function independently of the test run unit 60 and, for example, have stored or randomly generated a virtual driving environment. A complete representation of a real test drive can thus be provided via the vehicle test stand 1 in FIG. 2.

FIG. 3 shows an advantageous embodiment of signal transmission on the vehicle test stand 1. For this purpose, the test run unit 60 can load an environmental model 93 with stored reference maneuvers. The environment model 93 can preferably run on the simulation unit 6 and be part of a test stand control unit. Advantageously, the reference maneuver is used in the closed-loop operation of a test run unit 60. The data of the environmental model 93 are used in the vehicle model 91 to prespecify weather conditions, terrain, road conditions, etc., and can be used, for example, in a drive model 94. A drive model 94 can also include a tire model, but it is also possible that the tire model be designed separately. On the basis of the included models, e.g., the tire model, and on the basis of the environment model 93, the vehicle model 91 can calculate a target value as a target rotational speed nₛ for the driven wheel, e.g., the rear wheel 73. The target rotational speed nₛ can then be transmitted, for example, to a controller such as a rotational speed controller unit 11, which can also be part of the loading unit 10. By means of a suitable controller, the rotational speed controller unit 11 can calculate a suitable manipulated variable as a rotational speed manipulated variable SGₙ for the loading unit 10 from the determined target rotational speed nₛ and a detected actual rotational speed nᵢ. A torque D detected at the loading unit 10 can, for example, be fed back as an actual value to the simulation unit 6, in particular to the vehicle model 91. For example, a rotational speed signal nᵢ from a vehicle-mounted rotational speed sensor can be used as the actual value for the rotational speed controller unit 11 (dashed arrow). If an actual value is not used, only one controller can also be implemented on the loading unit 10.

The vehicle model 91 can moreover contain a steering model 95 of the steering system 7, which can also receive data from the environmental simulation 93. This makes it possible to determine a target value such as a target steering counter force Q_{A,S}, which can be transmitted, for example, to a force controller 24, which calculates a manipulated variable as a steering counter force value manipulated variable SG_{Q} for the steering force module 2. The force controller 24 can be part of the steering force module 2. The steering angle α_{M}, which is detected by the steering angle detection unit 20, can be used as an input variable for the vehicle model 91, in particular for the steering model 95 of the steering system 7. The steering angle α_{M} is transmitted to the force controller 24 and to the steering model 95 of the steering system 7. A force sensor, e.g., in the form of a piezoelement or strain gage, arranged on the steering force module 2, can be used as the actual value for the force controller 24 and can output an actual steering counter force value Q_{A,i} (dashed arrow). If an actual value is not used, only one controller can also be implemented in the steering force module 2.

The two closed-loop and/or open-loop controllers described are of course not to be regarded as conclusive. Other closed-loop and/or open-loop controllers which a person skilled in the art considers necessary may be implemented in the vehicle test stand.

1. A vehicle test stand for carrying out a test run with a banking-capable complete vehicle, comprising:
a steering force module that is provided on the vehicle test stand, which is configured to be connected to a steering system of the banking-capable complete vehicle, wherein a steering angle detection unit is provided in order to detect a steering angle of the steering system during the test run, wherein a detection unit is provided in order to detect a position of a driver relative to the banking-capable complete vehicle during the test run, wherein a simulation unit is provided which is designed to use the steering angle and the position of the driver in a simulation model in order to calculate a steering counter force acting on the steering system and counteracting a steering force exerted by the driver, and wherein the steering force module is designed to apply the steering counter force (Q_{A}) to the steering system.

2. The vehicle test stand according to claim 1, wherein a vertical axis of the banking-capable complete vehicle is in the same, vertical, test position during the entire test run.

3. The vehicle test stand according to claim 1, wherein a loading unit for driving or loading the banking-capable complete vehicle is provided in the vehicle test stand, in particular in order to exert a torque on a component of a drive train of the banking-capable complete vehicle.

4. The vehicle test stand according to claim 3, wherein the loading unit has at least one roller on which a rear wheel or a front wheel of the banking-capable complete vehicle can be arranged.

5. The vehicle test stand according to claim 1, wherein the steering angle detection unit is arranged in the steering force module.

6. The vehicle test stand according to claim 1, wherein a test run unit is provided which is designed to perform prespecified reference maneuvers on the vehicle test stand in the course of the test run, wherein the reference maneuver contains recorded data of a real test drive of a test vehicle.

7. The vehicle test stand according to claim 1, wherein a visualization unit is provided on the vehicle test stand in order to generate a virtual driving environment during the test run.

8. The vehicle test stand according to claim 1, wherein the simulation model has a multi-body model, wherein the multi-body model preferably has a vehicle model and a driver model.

9. The vehicle test stand according to claim 1, wherein the test run unit is designed to prespecify stored data to an environmental model, and environmental conditions are simulated during the test run.

10. The vehicle test stand according to claim 1 one of claim 1, wherein the vehicle test stand has a brake pressure measurement unit which is configured to measure a brake pressure in a brake system of the complete vehicle and that the simulation unit or the test run unit is designed to use the detected brake pressure to determine a virtual braking torque.

11. The vehicle test stand according to claim 1, wherein the vehicle test stand has a rotational speed signal unit which is configured to emulate a wheel rotational speed signal at an unloaded wheel.

12. The vehicle test stand according to claim 1, wherein the simulation unit is configured to prespecify a target steering counter force to a force controller, and the force controller is moreover designed to determine a steering counter force value manipulated variable.

13. A method for carrying out a test run with a banking-capable complete vehicle on a vehicle test stand, wherein a steering force module is provided on the vehicle test stand and is connected to a steering system of the banking-capable complete vehicle, wherein a steering angle of the steering system is detected during the test run, that a position of a driver relative to the banking-capable complete vehicle is detected during the test run, wherein a steering counter force acting on the steering system and counteracting a steering force exerted by the driver is calculated from the detected steering angle and the recorded position (αL) of the driver using a simulation model, and wherein the steering counter force is applied to the steering system using the steering force module.

14. The method according to claim 13, wherein during the test run on the vehicle test stand, a reference maneuver stored in a test run unit is reproduced, wherein the reference maneuver contains recorded data of a real test drive of a test vehicle.

15. The method according to claim 13, wherein during the test run, a virtual driving environment is generated on the vehicle test stand by means of a visualization unit.

16. The method according to claim 13, wherein stored data are prespecified to an environmental model via the test run unit, and environmental conditions during the test run are simulated with the environmental model.

17. The method according to claim 13, wherein a vertical axis of the banking-capable complete vehicle is held in the same, vertical, test position during the test run.

18. The method according to claim 13, wherein a brake pressure in a brake system of the complete vehicle is detected, and the detected brake pressure is used to determine a virtual braking torque.

19. The method according to claim 13 wherein a wheel rotational speed of a driven wheel of the complete vehicle is detected and is used to emulate a wheel rotational speed signal at a stationary wheel of the complete vehicle.
